(19) United States
(12) Patent Application Publication
(10) Pub. No.: US 2012/0079229 A1
(43) Pub. Date: Mar. 29, 2012

(54) DATA STORAGE OPTIMIZATION FOR A VIRTUAL PLATFORM

(76) Inventors: Craig Jensen, Clearwater, FL (US); Gary Quan, La Crescenta, CA (US); Richard Cadruvi, Simi Valley, CA (US); Basil Thomas, Sylmar, CA (US)

(21) Appl. No.: 12/892,790

(22) Filed: Sep. 28, 2010

(51) Int. Cl. G06F 12/02; G06F 12/00

(52) U.S. Cl. 711/170; 711/202; 711/E12.001; 711/E12.002

(57) ABSTRACT

A method for storing data in virtual system is described. The method includes selecting virtual blocks in the virtual disk for storage of data based on contiguous logical blocks, in a disk file residing on physical storage media, that are mapped to the virtual blocks.

### FIELD OF THE INVENTION

The present invention relates to data storage in general. More specifically, the invention relates to optimizing data storage for a virtual platform.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Free space fragmentation and data fragmentation result in inefficiencies that generally reduce storage capacity and performance. Free space fragmentation occurs when free space in storage media is available as many small pieces instead of large contiguous pieces that can store entire data files in contiguous locations. Storing a data file in storage media with a high level of free space fragmentation may require data fragmentation, e.g., breaking a data file into small portions and storing each piece separately into free space fragments that are only large enough to store portions of the data file.

Storing files in multiple free space fragments (when a storage media has a high level of free space fragmentation) or reading files from multiple locations (when a storage media has a high level of data fragmentation) may result in reduced I/O speed (e.g., due to an increase in number of different storage locations to be accessed, an increase in I/O processing, an increase in seek time, rotational delay of a read/write head, etc.).

The fragmentation problem is amplified in virtual systems. In virtual systems, virtual blocks that store a data file are mapped to logical blocks and/or physical blocks residing on storage media. Consequently, fragmentation can occur at multiple levels. For example, fragmentation can occur on the virtual disk itself, where a fragmented data file may be stored across multiple non-contiguous virtual blocks in the virtual disk. Furthermore, even when a data files is stored across contiguous virtual blocks, the file may still be fragmented because those virtual blocks may be mapped to many fragmented or non-contiguous logical blocks residing on physical storage media. When the virtual blocks map to non-continuous logical blocks, a read or write to the virtual blocks requires a non-sequential read or write of the logical blocks in the disk file residing on physical storage media.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B are block diagrams illustrating a virtual system in accordance with an embodiment;

FIG. 2 is a flow diagram illustrating an embodiment for storing data in a virtual system;

FIG. 3 is a block diagram example illustrating a data mapping from a virtual disk to a disk file on physical storage media;

FIG. 4A is a block diagram example illustrating an initial state of a virtual system;

FIGS. 4B-4E are block diagram examples illustrating possible defragmented states of a virtual system;

FIG. 5 is a block diagram of a system in accordance with an embodiment.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Several features are described hereafter that can each be used independently of one another or with any combination of the other features. However, any individual feature might not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in the specification.

### Overview

Reading or writing data on virtual storage involves reading or writing data from the disk file, residing on physical storage media, to which the virtual storage is mapped. Accordingly, fragmentation of the disk file and virtual storage reduces I/O performance of the virtual storage.

In an embodiment, the present invention optimizes I/O performance of the virtual storage by selecting the virtual blocks in the virtual storage for data and free space storage based on the logical blocks in the disk file to which the virtual blocks are mapped to. Selection of the virtual blocks may be for the initial storage of a data file or during defragmentation of the virtual disk and/or defragmentation of the disk file. In an embodiment, particular virtual blocks in the virtual storage are selected for storage of a data file on the basis that the particular virtual blocks are mapped to contiguous logical blocks in the disk file residing on physical storage media. The particular virtual blocks may themselves be contiguous or non-contiguous. A data file may even be transferred from contiguous virtual blocks to non-contiguous virtual blocks in the virtual storage, thereby fragmenting the virtual storage, if the non-contiguous virtual blocks are mapped to contiguous logical blocks in the disk file residing on physical storage media. Storing a data file in contiguous logical blocks in the disk file allows for a sequential read and/or write of the physical storage media. In an embodiment, sequential read and/or write is guaranteed at both the virtual disk level and the disk file level, by selecting contiguous virtual blocks in the virtual storage for storage of a data file that maps to contiguous logical blocks in the disk file.

In an embodiment, defragmenting a virtual system comprises re-mapping one or more virtual blocks in the virtual disk, that store a data file, from non-contiguous logical blocks to contiguous logical blocks in the disk file. The defragmenting of the virtual system further involves transferring the data from the non-contiguous logical blocks to the contiguous logical blocks in the disk file (e.g., deleting a data file from the non-contiguous logical blocks and storing the data file in the contiguous logical blocks).

In an embodiment, defragmenting a virtual system comprises reordering the logical blocks in a disk file. For example, the logical blocks in a disk file may be reordered such that two non-contiguous blocks storing a data file become two contiguous logical blocks. Accordingly, a sequential read and/or write associated with the data file may be executed on the contiguous logical blocks.

Although specific components are recited herein as performing the method steps, in other embodiments agents or mechanisms acting on behalf of the specified components may perform the method steps. Further, although the invention is discussed with respect to components on a single system, the invention may be implemented with components distributed over multiple systems. Embodiments of the invention also include any system that includes the means for performing the method steps described herein. Embodiments of the invention also include a computer readable medium with instructions, which when executed, cause the method steps described herein to be performed.

### System Architecture

Although a specific computer architecture is described herein, other embodiments of the invention are applicable to any architecture that can be used to optimize data storage in a virtual system.

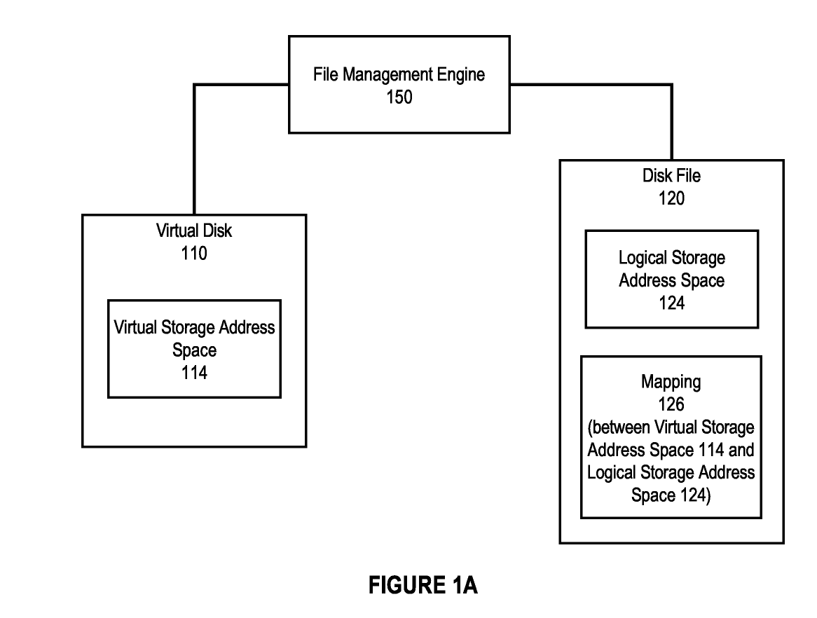

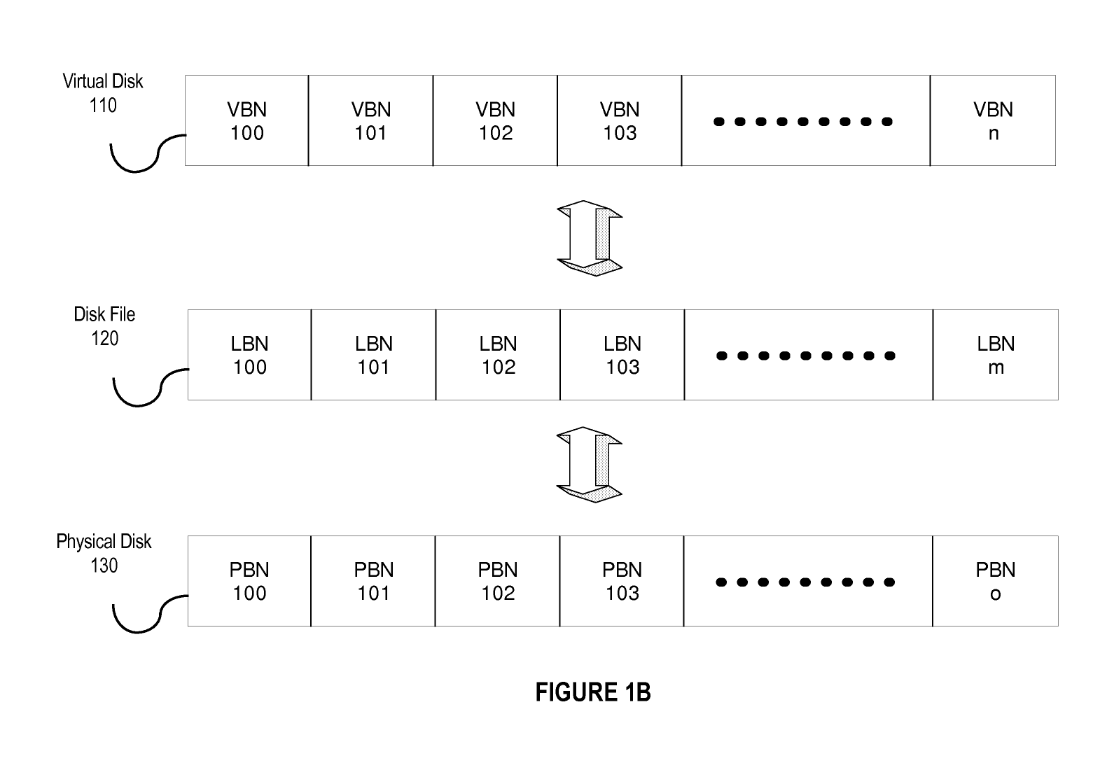

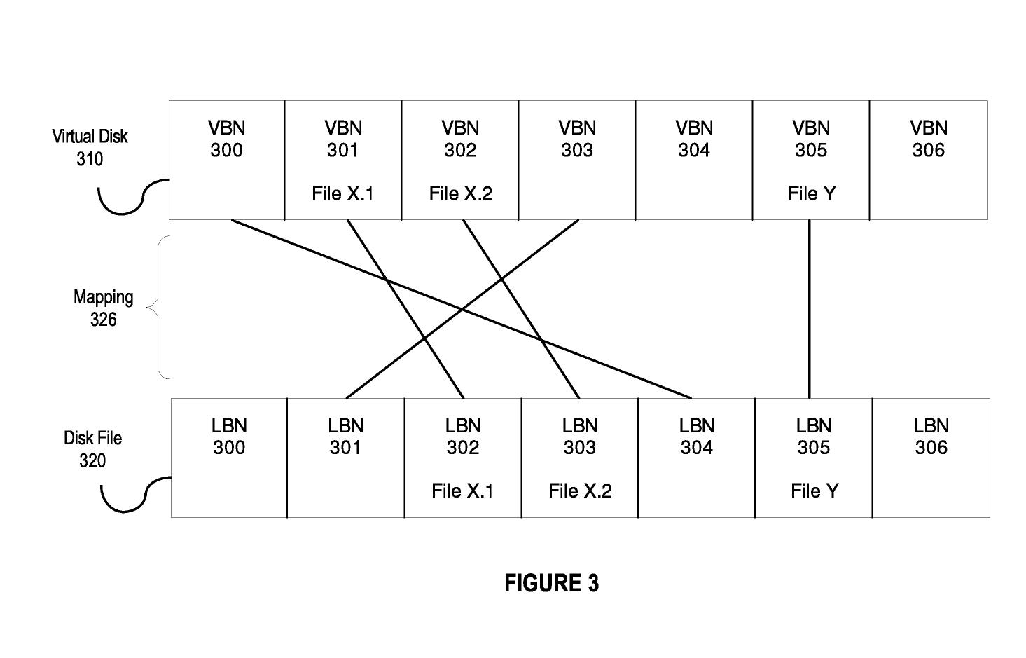

FIGS. 1A and/or 1B show a virtual disk (110), a disk file (120), and a physical disk (130) in accordance with one or more embodiments. Any of the components shown in FIGS. 1A and/or 1B may be implemented on a single device or multiple devices. Furthermore, although specific sub-components (e.g., mapping (126)) are shown as part of a particular component (e.g., disk file (120)), the sub-components may be a part of or maintained by any component. FIG. 3 shows a block diagram example illustrating an example data mapping (326) from a virtual disk (310) to a disk file (320) on physical storage media.

### The Virtual Disk

In an embodiment, the virtual disk (110) generally represents any virtual storage address space (114) that may be referred to by an application, operating system, or other suitable software. The virtual storage address space (114) may be divided into pages, where each page corresponds to a virtual block of contiguous virtual storage addresses in the virtual storage address space. A logical block, virtual block, or physical block, as described herein, may refer to a logical sector, virtual sector, or physical sector, respectively. Further, the terms “block” and “sector” may be used interchangeably herein. The size of a page or block in the system may be determined based on any suitable characteristics of the system. For example, each block may be defined as 2048 bytes or 4096 bytes. FIG. 1B shows an example of multiple virtual blocks (e.g., virtual block number 100 to virtual block number n) in the virtual disk (110) that are mapped to logical blocks (e.g., logical block number 100 to logical block number m) in the disk file (120) residing on physical storage media. The virtual blocks in the virtual disk (110) may originally be mapped to logical blocks in the disk file (120) in groups (e.g., a group of 100 contiguous virtual blocks being mapped to a group of 100 contiguous logical blocks). A portion of the virtual storage address space (114) used by an application may span across multiple virtual blocks. For example, an application may use contiguous virtual blocks (e.g., VBN 101 and VBN 102) or non-contiguous virtual blocks (e.g., VBN 101 and VBN 103) to store a data file. A data file stored on non-contiguous virtual blocks in virtual disk (110) is considered “virtually-fragmented”. A single virtual block in the virtual disk (110) may be mapped to a single logical block or multiple logical blocks in the disk file (120). Data that is referred to herein as stored in a virtual block in the virtual disk (110) is stored in the one or more logical blocks in the disk file (120) residing on physical storage media. The virtual block is mapped to the corresponding logical blocks in the disk file (120) that store the data. In addition, virtual blocks in the virtual disk (110) that are not currently in use may not necessarily be mapped to logical blocks in the disk file (120). Accordingly, the size of the virtual storage address space (114) may be larger than the actual disk file (120) corresponding to the virtual storage address space (114).

### Disk File

The disk file (120) generally represents logical storage address space (124) residing on physical storage media for storage of the data in the virtual disk (110). The disk file (120) may also be referred to as a Virtual Hard Disk file or Virtual Disk file as the virtual disk is mapped to the disk file (120). However, for clarity, the present application refers to the virtual hard disk file or virtual disk file simply as a disk file (120). Each logical storage address of the disk file (120) corresponds to a specific address on the physical storage media (e.g., solid state drive, rotating platter drive, etc.). For example, a physical storage media address may be obtained by adding an offset to the logical storage address. In an embodiment, portions of the disk file (120) may be stored on secondary storage at given time and pages from the disk file (120) may be loaded into main memory during reading and/or writing of corresponding virtual blocks in the virtual disk (110). Accordingly, the disk file (120) may be distributed over different types of storage and over different systems. However, for simplicity, the disk file (120) is simply referred to herein as residing on physical storage media.

The disk file (120) may include the mapping (126) between the virtual storage address space (114) and the logical storage address space (124). The mapping (126) generally represents any association between addresses in the virtual storage address space (114) and addresses in the logical storage address space (124). The mapping (126) may include an association between a specific virtual storage address and a specific logical storage address. The mapping (126) may refer to a block by block mapping, where blocks in the virtual storage address space (e.g., virtual blocks) are mapped to blocks in the logical storage address space (e.g., logical blocks). Embodiments described herein, with reference to block by block mapping may be equally applicable to a sector by sector mapping or a page by page mapping. Examples herein may refer to a specific type of mapping for purposes of clarity and ease of understanding. The mapping (126) may be include a one-to-one mapping, a one-to-many mapping or a many-to-many mapping. The mapping (126) may be uni-directional or bi-directional. For example, uni-directional mapping may include information where virtual blocks in the virtual disk (110) have pointers to logical blocks in the disk file (120). Another example of uni-directional mapping includes information where logical blocks in the disk file (120) are mapped to virtual blocks in the virtual disk (110). A bi-directional mapping includes mapping information of virtual blocks to logical blocks and also, logical blocks to virtual blocks. The mapping (126) may be static or dynamic. For example, once a virtual storage address is allocated and data is stored at the virtual storage address, a permanent mapping to a corresponding logical storage address (where the data is actually stored) may be created until data at the virtual storage address is deleted. A dynamic mapping includes a mapping between virtual blocks and logical blocks that may be modified. For example, a pointer from a virtual block that points to a first logical block may be modified to point a different second logical block. Furthermore, data from the first logical block may be transferred to the second logical block in order to maintain data consistency at the virtual block.

### Physical Disk

In an embodiment, the logical blocks in the disk file (120) are mapped to physical memory blocks (e.g., physical block number (PBN) 100 to PBN o) in the physical disk (130). The physical disk (130) generally represents any storage media that includes functionality to store data. Examples of the physical disk include magnetic disks, optical disks, magneto-optical disks, solid state drives, etc. The physical disk (130) may also represent any combination of storage media. For example, the physical disk (130) may be implemented as a combination of a solid state drive and a rotating platter drive.

### File Management Engine

In an embodiment, the file management engine (150) generally represents any software and/or hardware components that manage data in a virtual system (e.g., data on the virtual disk (110) or the disk file (120)). One or more portions of the file management engine (150) may be implemented as part of an application or operating system executing on the virtual storage address space (114) or executing on the logical storage address space (124) in the disk file (120). The file management engine (150) may select the virtual blocks in the virtual disk (110) for initial storage of a data file or for storage of a previously stored data file (e.g., during a modification of the file or during a defragmentation process). The file management engine (150) may be configured to obtain metadata associated with the logical storage address space (124) in the disk file (120) and/or to obtain the mapping (126) between the virtual storage address space (114) and the logical storage address space (124). The file management engine (150) may be configured to select virtual blocks in the virtual disk for storing a data file based, at least in part, on the mapping (126) between the virtual storage address space (114) and the logical storage address space (124). In an embodiment, the file management engine (150) may be configured to detect contiguous logical blocks in the disk file (120) that are available for data storage. In an embodiment, the file management engine (150) may be configured to determine where to store a data file in the disk file (120) residing on physical storage media. For example, the file management engine (150) may select logical blocks in the disk file (120) to store a data file that is “stored” on the virtual disk.

Although the file management engine (150) is shown as a single component, the file management engine (150) may be distributed into independently operating processes. For example, one file management engine may execute all operations involving the virtual disk (110) and a second file management engine may execute all operation involving the disk file (120). The file management engine for each may be communicatively coupled to manage the virtual system as a whole.

### Storing Data in a Virtual System

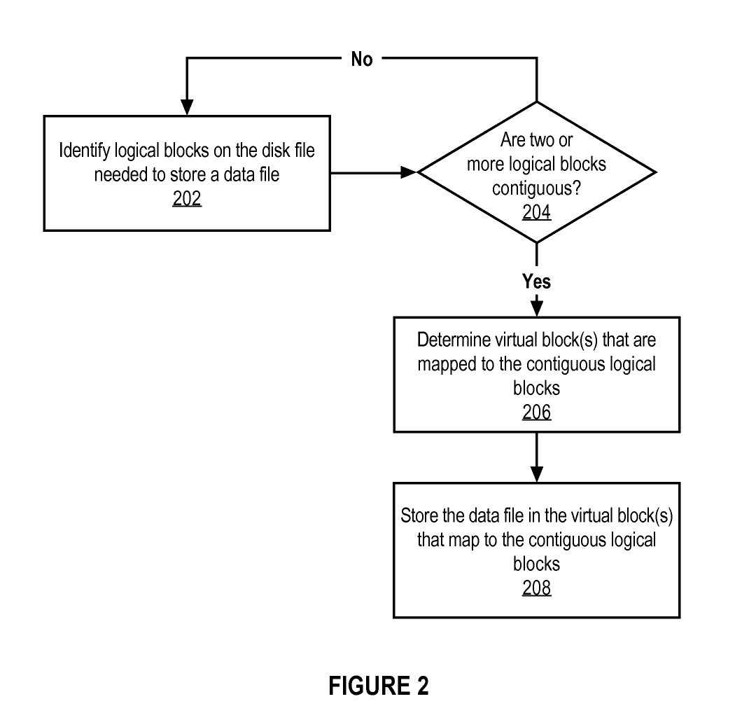

FIG. 2 is a flow diagram illustrating an embodiment for storing data in a virtual system. One or more of the steps described below may be omitted, repeated, and/or performed in a different order. Accordingly, the specific arrangement of steps shown in FIG. 2 should not be construed as limiting the scope of the invention.

The method for storing data in the virtual system as illustrated in FIG. 2 may be used for storing a data file (e.g., when a data file is being initially stored, when the data file is being stored after modification, when a data file is being stored during a defragmentation process, etc.). Initially, a determination is made as to how many logical blocks in the disk file will be required to store a data file. For example, for an application executing on a virtual system, an estimate of the required virtual storage space may be determined. Another example may involve storage of a media content file by a virtual system where the size of the media content file is known in advance. Based on the size of the virtual storage space, the necessary number of logical blocks are identified for storage of the data file (Step 202). The logical blocks may be identified by checking the disk file in a sequential order to identify logical blocks available for storage. Alternatively, a list of available logical blocks may be accessed to identify the logical blocks. If the identified logical blocks are not contiguous (Step 204), a new set of logical blocks are identified until a contiguous set of logical blocks in the disk file is found. In an embodiment, data may be transferred from one logical block to another logical block to obtain a set of contiguous logical blocks that are available for storage of the data file. The transfer of the data from one logical block to another logical block may also involve updating the mapping of the corresponding virtual blocks from the logical block previously containing the data to the logical block now containing the data. Accordingly, the virtual block that is “storing” the data effectively maintains a pointer to the data in the disk file residing on the physical storage media.

In an embodiment, virtual blocks that are mapped to the contiguous logical blocks in the disk file are determined (Step 206). The virtual blocks may be determined based on a mapping between the virtual blocks and the contiguous logical blocks. For example, pointers to and/or from the contiguous logical blocks may be used to determine the virtual blocks which are mapped to the contiguous logical blocks. In an embodiment, during defragmentation of the virtual system, determining the virtual blocks that are mapped to the contiguous logical blocks includes remapping particular virtual blocks to the identified contiguous logical blocks.

Once the virtual blocks that map to contiguous logical blocks are determined, the virtual system stores the data file in the virtual blocks (Step 208). When a command to store the data file in the virtual blocks is executed, the data file is stored onto the logical blocks in the disk file that the virtual blocks are mapped to. Subsequent reads and/or writes to the virtual blocks in the virtual disk result in subsequent reads and/or writes to the corresponding logical blocks in the disk file.

In an embodiment, the mapping from a virtual block to a corresponding logical block may not be determined until a command for storing the data file to the virtual block is executed. In this scenario, subsequent to executing the command for storing the data file to the virtual blocks, contiguous logical blocks suitable for storing the data file are identified. Thereafter, a mapping between the virtual blocks and the contiguous logical blocks is created and the data file is stored in the contiguous logical blocks.

### Defragmenting a Virtual System

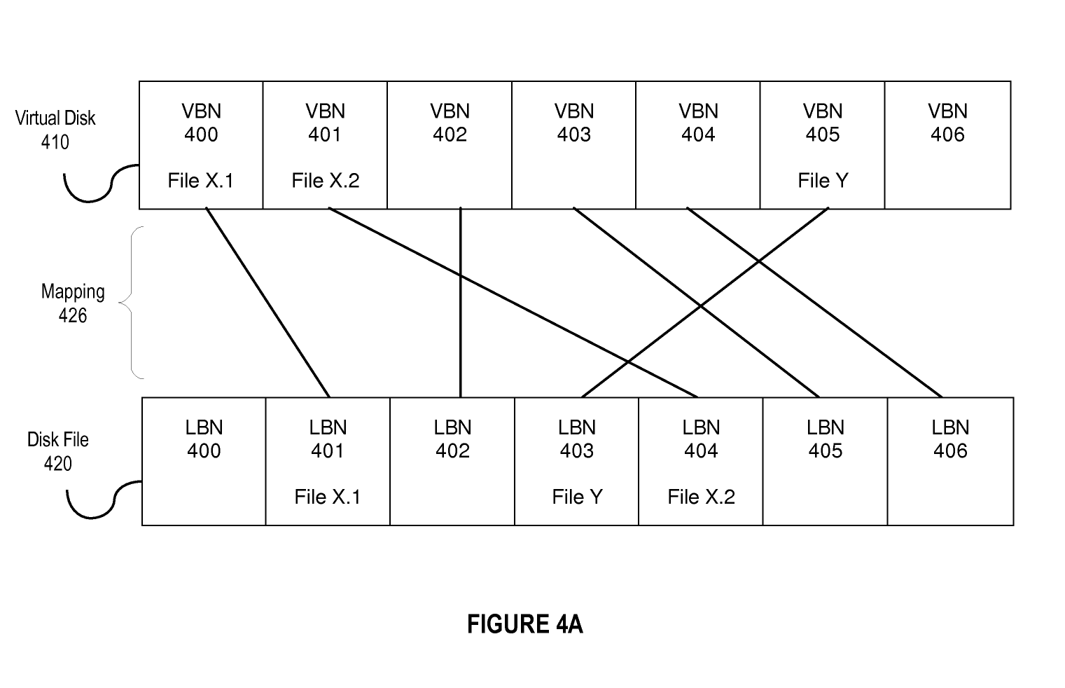

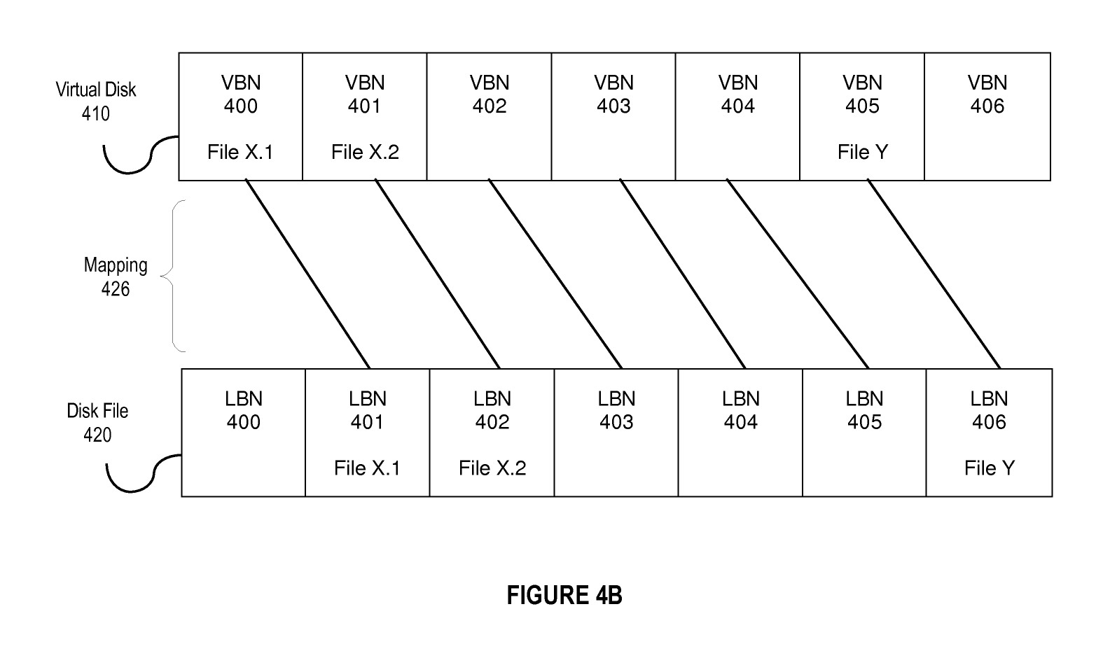

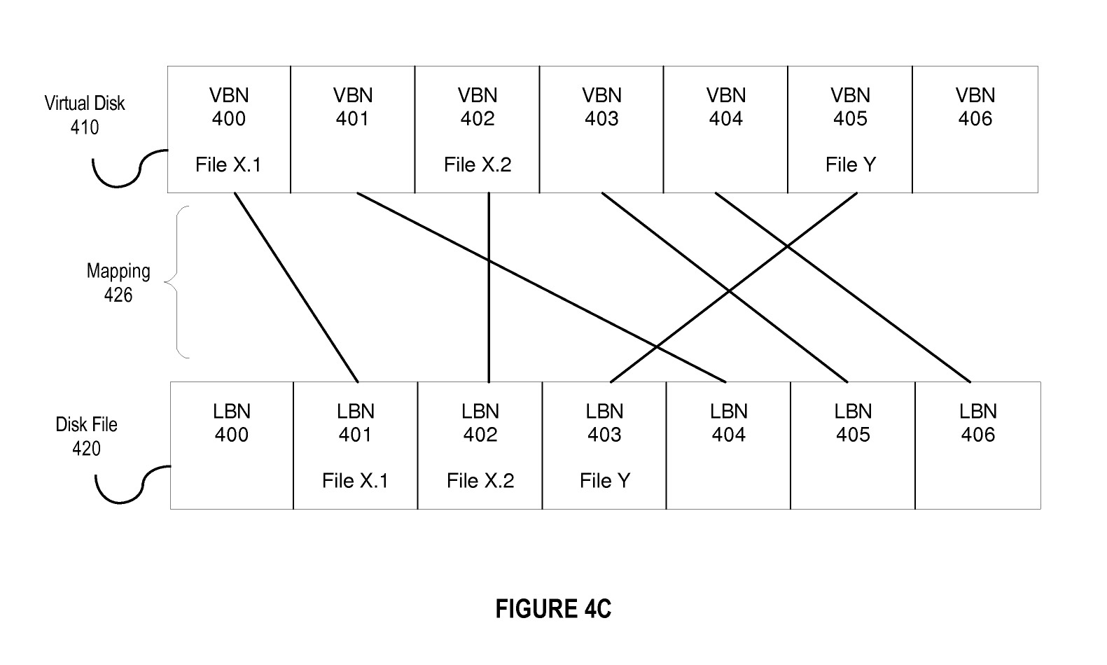

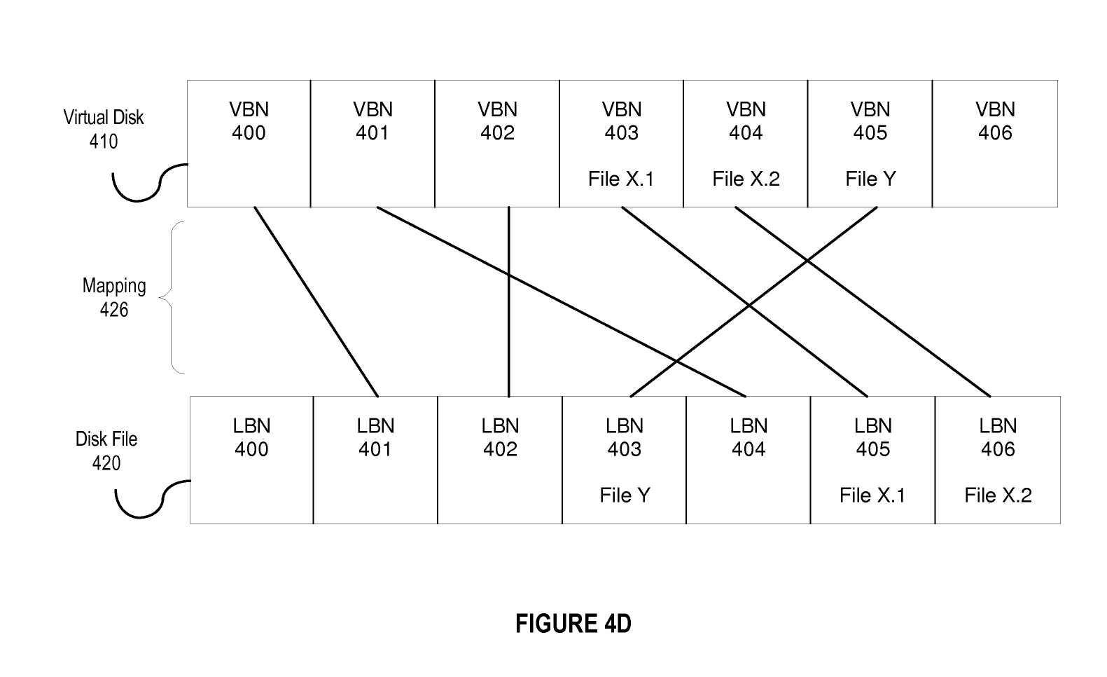

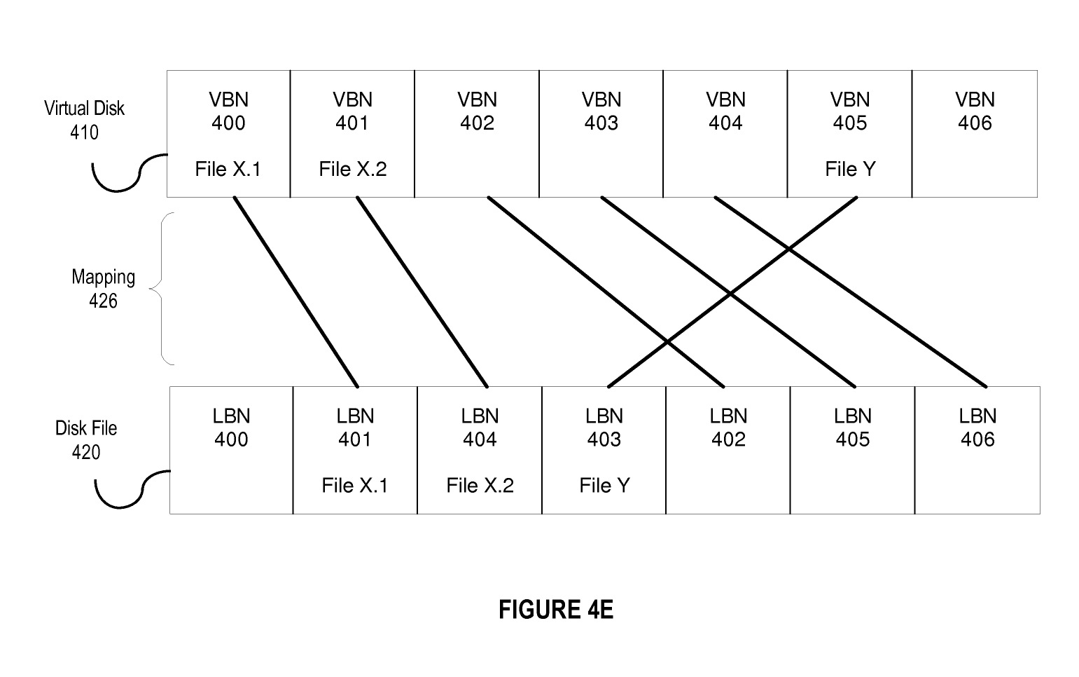

FIG. 4A is a block diagram example illustrating an initial state of a virtual system prior to defragmentation of the virtual system. As shown in FIG. 4A, virtual blocks in the virtual disk (410) are mapped to logical blocks in the disk file (420). File X is “stored” in two parts (e.g., file X.1 and file X.2) in Virtual Block Number (VBN) (400) and VBN (401). VBN (400) and VBN (401) are mapped to Logical Block Number (LBN) (401) and LBN (404) in the disk file (420). Thus, while file X is not virtually-fragmented, file X is “logically-fragmented” because the logical blocks on which file X is stored are not contiguous.

Accordingly, any command to read and/or write to VBN (400) and VBN (401) results in the reading and/or writing of LBN (401) and LBN (404). In this case, the reading and/or writing of File X is a sequential read and/or write at the virtual disk level because VBN (400) and VBN (401) are contiguous virtual blocks. However, since File X is actually stored in LBN (401) and LBN (404), which are non-contiguous logical blocks in the disk file residing on physical storage media, a read and/or write of File X results in a non-sequential read and/or write from physical storage media. A non-sequential read and/or write from physical storage media is not desirable due to poor performance in comparison to a sequential read and/or write. As a result, defragmentation of the physical storage media in a virtual system may improve performance, in accordance with one or more embodiments. The defragmentation may be initiated automatically by the virtual system based on a fragmentation level (e.g., percentage of files that fragmented), based on a command from a user, based on a periodically scheduled maintenance of the virtual system, or based on any other suitable mechanism.

### Change Mapping Without Changing Virtual Blocks

FIG. 4B illustrates a possible defragmented state of the virtual system presented in FIG. 4A. As seen in comparison to FIG. 4A, the mapping from the virtual disk (410) to the disk file (420) is modified in FIG. 4B. In accordance with an embodiment, the defragmentation process involves re-mapping virtual blocks in the virtual disk (410) to the logical blocks in the disk file (420) in a sequential manner. In this example, the mapping from VBN (401) to LBN (404) is modified from VBN (401) to LBN (402). Modifying the mapping may be performed by modifying corresponding pointers. For example, a pointer (or a memory address) stored in association with VBN (401) may be modified to point to LBN (402) instead of pointing to LBN (404). Furthermore, the data is transferred from LBN (404) to LBN (402). Transferring the data may involve exchanging the data in the LBN (402) and LBN (404). If LBN (404) is no longer being used, transferring the data may simply involve storing the data in LBN (402). Accordingly, the virtual blocks storing a file are remapped to contiguous logical blocks in the disk file (120). Furthermore, the data is transferred to the contiguous logical blocks in the disk file to allow for sequential I/O of the data file X.

### Change to Non-Contiguous Virtual Blocks Mapped to Contiguous Logical Blocks

FIG. 4C illustrates another possible defragmented state of the virtual system presented in FIG. 4A. In an embodiment, virtual blocks in the virtual disk are selected for storage of a data file based on the logical blocks in the disk file that the virtual blocks are mapped to. In this example, LBN (401) and LBN (402) are determined to be contiguous logical blocks suitable for storing the data file X. Accordingly, VBN (400) and VBN (402) are selected for storage of data file X on the virtual disk, even though VBN(400) and VBN(402) are not contiguous, because VBN (400) and VBN (402) are respectively mapped to LBN (401) and LBN (402), which are contiguous.

In this example, in order to defragment the data file X at the disk file level, at least a portion of the data file X is transferred at the virtual disk level. Specifically, a command is executed to move file X.2 from VBN (401) to VBN (402) and as a result, at the disk file (420), file X.2 is now stored in LBN (402) which is mapped from VBN (402). In this new configuration, file X.1 and file X.2 are stored in two contiguous logical blocks (e.g., LBN (401) and LBN (402)) in the disk file. A read and/or write of file X will now involve the sequential read and/or write of file X.1 and file X.2 from LBN (401) and LBN (402), respectively.

In an embodiment that uses the technique illustrated in FIG. 4C, during a defragmentation process in a virtual system, the virtual disk is intentionally fragmented (e.g., transferring file X.2 from VBN (401) to VBN (402)) to defragment the disk file residing on physical storage media. This allows for a sequential read and/or write of physical storage media which may result in better I/O performance than a sequential read and/or write of the virtual disk.

### Change to Contiguous Virtual Blocks Mapped to Contiguous Logical Blocks

FIG. 4D illustrates another possible defragmented state of the virtual system presented in FIG. 4A. In an embodiment, defragmentation involves defragmentation at both the virtual disk level and the disk file level. Such a multi-level defragmentation involves identifying contiguous virtual blocks in the virtual disk as well as contiguous logical blocks in the disk file, where the contiguous virtual blocks are mapped to the contiguous logical blocks. The multi-level defragmentation ensures a sequential read and/or write at both the virtual disk level and the disk file level. In this example, a pair of contiguous virtual blocks (e.g., VBN (403) and VBN (404)) in the virtual disk that are mapped to a pair of contiguous logical blocks (e.g., LBN (405) and LBN (406)) are identified. The identification may be performed by first finding a set of contiguous virtual blocks that are available and thereafter determining whether the logical blocks mapped to the set of contiguous virtual blocks are contiguous logical blocks. If the logical blocks are not contiguous, the process may be repeated with another set of contiguous virtual blocks. Alternatively, contiguous logical blocks may first be identified and the virtual blocks that map to the contiguous logical blocks may be checked. The process may be repeated until contiguous virtual blocks that map to contiguous logical blocks are found. Thereafter, in this example, the data file X is transferred from VBN (400) and VBN (401) to VBN (403) and VBN (404). Furthermore, based on the transfer, the data file X is then stored in LBN (405) and LBN (406) at the disk file level which are mapped from VBN (403) and VBN (404). In this defragmented state a read and/or write to data file X would result in a sequential read and/or write of VBN (403) and VBN (404) at the virtual disk level and also a sequential read and/or write of LBN (405) and LBN (406) at the disk file level.

### Reorder Logical Blocks

FIG. 4E illustrates another possible defragmented state of the virtual system presented in FIG. 4A. In an embodiment, defragmentation involves modifying the ordering of the logical blocks in the disk file (420). In this example, prior to defragmentation, the virtual disk stores two parts of a data file (e.g., file X.1 and file X.2) in VBN (400) and VBN (401) which map to LBN (401) and LBN (404) in the disk file. As a result, when a command to read and/or write the data file is executed, a non-sequential I/O operation must be executed on LBN (401) and LBN (404). The non-sequential operation involves a disk reading process of reading a first physical storage media portion corresponding to LBN (401), then skipping the second physical storage media portion corresponding to LBN (402) and the third physical storage media portion corresponding to LBN (403), and reading from the fourth physical storage media portion corresponding to LBN (404). In an example, a non-sequential operation may involve moving a disk reading head from a particular physical storage media portion to another physical storage media portion in order to skip the reading of at least one physical storage media portion.

In this example, the defragmentation process switches LBN (402) with LBN (404) in the disk file. Accordingly, LBN (404) is now in the second position on the disk file and based on position, now corresponds to second physical storage media portion, adjacent to the first physical storage media portion, described above. In this example, a read and/or write to file X involves executing a command for reading and/or writing to LBN (401) in the disk file followed by reading and/or writing to LBN (404) since the two portions of file X are in LBN (401) and LBN (404). However, since LBN (401) and LBN (404) now correspond to adjacent physical storage media portions (e.g., the first physical storage media portion and the second physical storage media portion described above), the disk reading process is able to read the adjacent physical storage media portions sequentially without skipping over any intermediate physical storage media portions.

### EXAMPLES

In one or more embodiments, a method includes accessing a virtual disk including a plurality of virtual blocks; accessing a disk file associated with the virtual disk and including a plurality of logical blocks, where one or more virtual blocks, storing a data file, in the virtual disk are mapped to two or more non-contiguous logical blocks in the disk file; re-mapping the one or more virtual blocks in the virtual disk to two or more contiguous logical blocks in the disk file; transferring data from the two or more non-contiguous logical blocks in the disk file to the two or more contiguous logical blocks in the disk file; where the method is performed by at least one computing device. One or more virtual blocks in the virtual disk may include two non-contiguous virtual blocks in the virtual disk. Re-mapping the one or more virtual blocks in the virtual disk to two or more contiguous logical blocks in the disk file may include re-mapping the two non-contiguous virtual blocks in the virtual disk to the two or more contiguous logical blocks in the disk file. Re-mapping the one or more virtual blocks in the virtual disk to the two or more contiguous logical blocks in the disk file may be in response to detecting that: the data file is stored on the one or more virtual blocks in the virtual disk; and the one or more virtual blocks in the virtual disk are mapped to the two or more non-contiguous logical blocks in the disk file.

In one or more embodiments, a method includes accessing a virtual disk including a plurality of virtual blocks; accessing a disk file including a plurality of logical blocks, where one or more source virtual blocks in the plurality of virtual blocks are mapped to two or more non-contiguous logical blocks in the plurality of logical blocks; identifying one or more target virtual blocks in the plurality of virtual blocks that are mapped to two or more contiguous logical blocks in the plurality of logical blocks; requesting transfer of a data file from the one or more source virtual blocks to the one or more target virtual blocks; where transferring the data file from the one or more source virtual blocks to the one or more target virtual blocks results in transferring the data in the two or more non-contiguous logical blocks in the plurality of logical blocks to the two or more contiguous logical blocks in the plurality of logical blocks; where the method is performed at least one computing device. The source virtual blocks may be contiguous virtual blocks and the target virtual blocks may be non-contiguous virtual blocks, where moving the data file from the one or more source virtual blocks to the one or more target virtual blocks includes moving the data file from the contiguous virtual blocks to the non-contiguous virtual blocks. Transferring the data file from the one or more source virtual blocks to the one or more target virtual blocks may include fragmenting the data file on the virtual disk; where transferring the data in the two or more non-contiguous logical blocks in the plurality of logical blocks to the two or more contiguous logical blocks in the plurality of logical blocks includes defragmenting the data on the disk file. The one or more source virtual blocks may be a first set of contiguous virtual blocks and the one or more target virtual blocks may be a second set of contiguous virtual blocks, where moving the data file from the one or more source virtual blocks to the one or more target virtual blocks includes moving the data file from the first set of contiguous virtual blocks to the second set of contiguous virtual blocks. The one or more source virtual blocks and the one or more target virtual blocks may share at least one overlapping block.

In one or more embodiments, a method includes accessing a virtual disk including a plurality of virtual blocks; accessing a disk file associated with the virtual disk and including a plurality of logical blocks, where one or more virtual blocks, storing a data file, in the virtual disk are mapped to two or more non-contiguous logical blocks in the disk file; reordering at least two logical blocks in the disk file such that the two or more non-contiguous logical blocks are reordered as two or more contiguous logical blocks; where the method is performed by at least one computing device. The two or more non-contiguous logical blocks may be associated with two or more non-adjacent physical memory blocks, and the two or more contiguous logical blocks may be associated with two or more adjacent physical memory blocks.

In one or more embodiments, a method includes accessing a disk file associated with a virtual disk and including a plurality of logical blocks; accessing a virtual disk including a plurality of virtual blocks, where each virtual block of the plurality of virtual blocks are mapped to one or more logical blocks in the plurality of logical blocks; identifying two or more contiguous logical blocks in the plurality of logical blocks; determining that one or more virtual blocks are mapped to the two or more contiguous logical blocks; requesting storage of a data file on the one or more virtual blocks based on the one or more virtual blocks being mapped to the two or more contiguous logical blocks; where the method is performed by at least one computing device. The method may further include determining that the one or more virtual blocks are contiguous blocks; where requesting storage of the data file on the one or more virtual blocks is further based on the one or more virtual blocks being contiguous blocks.

One or more embodiments include an apparatus configured to perform one or more of the methods described above. One or more embodiments include a computer readable storage medium with instructions, which when executed, perform one or more of the methods described above.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

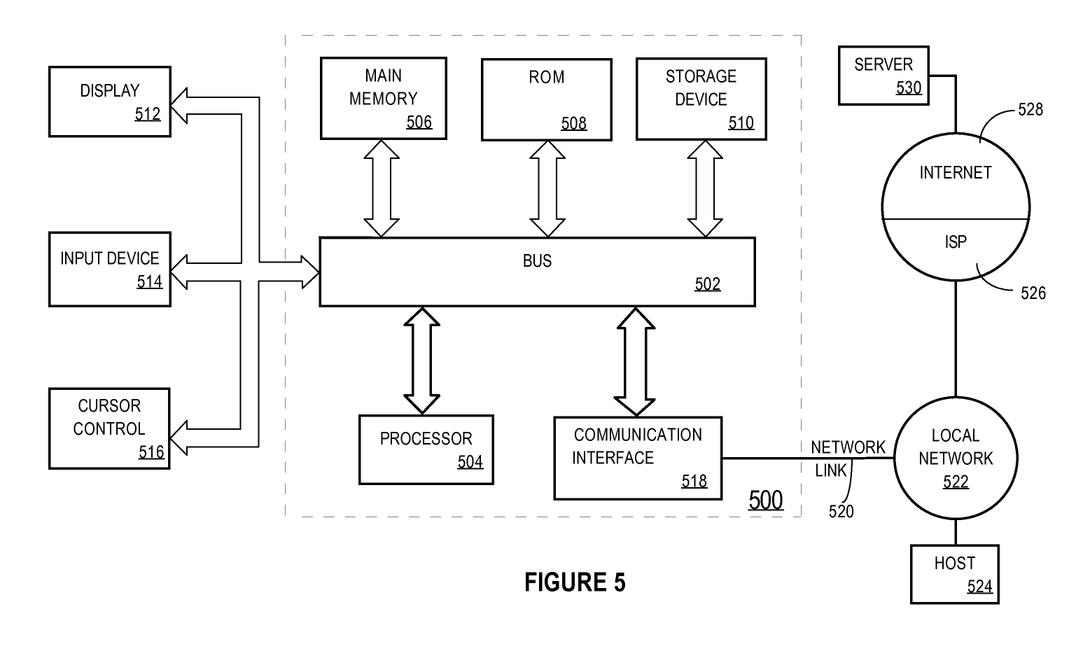

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

### Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A system comprising:
one or more processors;
a virtual disk comprising a plurality of virtual blocks;
a disk file associated with the virtual disk and comprising a plurality of logical blocks, wherein one or more virtual blocks, storing a data file, in the virtual disk are mapped to two or more non-contiguous logical blocks in the disk file;
a file management engine configured to:
re-map the one or more virtual blocks in the virtual disk to two or more contiguous logical blocks in the disk file;
transfer data from the two or more non-contiguous logical blocks in the disk file to the two or more contiguous logical blocks in the disk file.

2. The system as recited in claim 1, wherein the one or more virtual blocks in the virtual disk comprises two non-contiguous virtual blocks in the virtual disk.

3. The system as recited in claim 2, wherein re-mapping the one or more virtual blocks in the virtual disk to two or more contiguous logical blocks in the disk file comprises re-mapping the two non-contiguous virtual blocks in the virtual disk to the two or more contiguous logical blocks in the disk file.

4. The system as recited in claim 1, wherein the file management engine re-maps the one or more virtual blocks in the virtual disk to the two or more contiguous logical blocks in the disk file in response to detecting that:
the data file is stored on the one or more virtual blocks in the virtual disk; and
the one or more virtual blocks in the virtual disk are mapped to the two or more non-contiguous logical blocks in the disk file.

5. A system comprising:
a processor;
a virtual disk comprising a plurality of virtual blocks;
a disk file comprising a plurality of logical blocks, wherein one or more source virtual blocks in the plurality of virtual blocks are mapped to two or more non-contiguous logical blocks in the plurality of logical blocks;
a file management engine configured to:
identify one or more target virtual blocks in the plurality of virtual blocks that are mapped to two or more contiguous logical blocks in the plurality of logical blocks;
request transfer of a data file from the one or more source virtual blocks to the one or more target virtual blocks;
wherein transferring the data file from the one or more source virtual blocks to the one or more target virtual blocks results in transferring the data in the two or more non-contiguous logical blocks in the plurality of logical blocks to the two or more contiguous logical blocks in the plurality of logical blocks.

6. The system as recited in claim 5, wherein the source virtual blocks are contiguous virtual blocks and the target virtual blocks are non-contiguous virtual blocks, and wherein transferring the data file from the one or more source virtual blocks to the one or more target virtual blocks comprises transferring the data file from the contiguous virtual blocks to the non-contiguous virtual blocks.

7. The system as recited in claim 5,
wherein transferring the data file from the one or more source virtual blocks to the one or more target virtual blocks comprises fragmenting the data file on the virtual disk;
wherein transferring the data in the two or more non-contiguous logical blocks in the plurality of logical blocks to the two or more contiguous logical blocks in the plurality of logical blocks comprises defragmenting the data on the disk file.

8. The system as recited in claim 5, wherein the one or more source virtual blocks are a first set of contiguous virtual blocks and the one or more target virtual blocks are a second set of contiguous virtual blocks, and wherein transferring the data file from the one or more source virtual blocks to the one or more target virtual blocks comprises transferring the data file from the first set of contiguous virtual blocks to the second set of contiguous virtual blocks.

9. The system as recited in claim 5, wherein the one or more source virtual blocks and the one or more target virtual blocks share at least one overlapping block.

10. A system comprising:
a processor;
a virtual disk comprising a plurality of virtual blocks;
a disk file associated with the virtual disk and comprising a plurality of logical blocks, wherein one or more virtual blocks, storing a data file, in the virtual disk are mapped to two or more non-contiguous logical blocks in the disk file;
a file management engine configured to:
reorder at least two logical blocks in the disk file such that the two or more non-contiguous logical blocks are reordered as two or more contiguous logical blocks.

11. The system as recited in claim 10, wherein the two or more non-contiguous logical blocks are associated with two or more non-adjacent physical memory blocks, and wherein the two or more contiguous logical blocks are associated with two or more adjacent physical memory blocks.

12. A system comprising:
a processor;
a disk file associated with a virtual disk and comprising a plurality of logical blocks;
a virtual disk comprising a plurality of virtual blocks, wherein each virtual block of the plurality of virtual blocks are mapped to one or more logical blocks in the plurality of logical blocks;
a file management engine configured to:
identify two or more contiguous logical blocks in the plurality of logical blocks;
determine that one or more virtual blocks are mapped to the two or more contiguous logical blocks;
request storage of a data file on the one or more virtual blocks based on the one or more virtual blocks being mapped to the two or more contiguous logical blocks.

13. The system as recited in claim 12, wherein the file management engine is further configured to:
determine that the one or more virtual blocks are contiguous blocks;
wherein requesting storage of the data file on the one or more virtual blocks is further based on the one or more virtual blocks being contiguous blocks.

14. A method comprising:
accessing a virtual disk comprising a plurality of virtual blocks;
accessing a disk file associated with the virtual disk and comprising a plurality of logical blocks, wherein one or more virtual blocks, storing a data file, in the virtual disk are mapped to two or more non-contiguous logical blocks in the disk file;
re-mapping the one or more virtual blocks in the virtual disk to two or more contiguous logical blocks in the disk file;
transferring data from the two or more non-contiguous logical blocks in the disk file to the two or more contiguous logical blocks in the disk file;
wherein the method is performed by at least one computing device.

15. The method as recited in claim 14, wherein the one or more virtual blocks in the virtual disk comprises two non-contiguous virtual blocks in the virtual disk.

16. The method as recited in claim 15, wherein re-mapping the one or more virtual blocks in the virtual disk to two or more contiguous logical blocks in the disk file comprises re-mapping the two non-contiguous virtual blocks in the virtual disk to the two or more contiguous logical blocks in the disk file.

17. The method as recited in claim 14, wherein re-mapping the one or more virtual blocks in the virtual disk to the two or more contiguous logical blocks in the disk file is in response to detecting that:
the data file is stored on the one or more virtual blocks in the virtual disk; and
the one or more virtual blocks in the virtual disk are mapped to the two or more non-contiguous logical blocks in the disk file.

18. A method comprising:
accessing a virtual disk comprising a plurality of virtual blocks;
accessing a disk file comprising a plurality of logical blocks, wherein one or more source virtual blocks in the plurality of virtual blocks are mapped to two or more non-contiguous logical blocks in the plurality of logical blocks;
identifying one or more target virtual blocks in the plurality of virtual blocks that are mapped to two or more contiguous logical blocks in the plurality of logical blocks;
requesting transfer of a data file from the one or more source virtual blocks to the one or more target virtual blocks;
wherein transferring the data file from the one or more source virtual blocks to the one or more target virtual blocks results in transferring the data in the two or more non-contiguous logical blocks in the plurality of logical blocks to the two or more contiguous logical blocks in the plurality of logical blocks;
wherein the method is performed at least one computing device.

19. The method as recited in claim 18, wherein the source virtual blocks are contiguous virtual blocks and the target virtual blocks are non-contiguous virtual blocks, and wherein transferring the data file from the one or more source virtual blocks to the one or more target virtual blocks comprises transferring the data file from the contiguous virtual blocks to the non-contiguous virtual blocks.

20. The method as recited in claim 18,
wherein transferring the data file from the one or more source virtual blocks to the one or more target virtual blocks comprises fragmenting the data file on the virtual disk;
wherein transferring the data in the two or more non-contiguous logical blocks in the plurality of logical blocks to the two or more contiguous logical blocks in the plurality of logical blocks comprises defragmenting the data on the disk file.

21. The method as recited in claim 18, wherein the one or more source virtual blocks are a first set of contiguous virtual blocks and the one or more target virtual blocks are a second set of contiguous virtual blocks, and wherein transferring the data file from the one or more source virtual blocks to the one or more target virtual blocks comprises transferring the data file from the first set of contiguous virtual blocks to the second set of contiguous virtual blocks.

22. The method as recited in claim 18, wherein the one or more source virtual blocks and the one or more target virtual blocks share at least one overlapping block.

23. A method comprising:
accessing a virtual disk comprising a plurality of virtual blocks;
accessing a disk file associated with the virtual disk and comprising a plurality of logical blocks, wherein one or more virtual blocks, storing a data file, in the virtual disk are mapped to two or more non-contiguous logical blocks in the disk file;
reordering at least two logical blocks in the disk file such that the two or more non-contiguous logical blocks are reordered as two or more contiguous logical blocks;
wherein the method is performed by at least one computing device.

24. The method as recited in claim 23, wherein the two or more non-contiguous logical blocks are associated with two or more non-adjacent physical memory blocks, and
wherein the two or more contiguous logical blocks are associated with two or more adjacent physical memory blocks.

25. A method comprising:
accessing a disk file associated with a virtual disk and comprising a plurality of logical blocks;
accessing a virtual disk comprising a plurality of virtual blocks, wherein each virtual block of the plurality of virtual blocks are mapped to one or more logical blocks in the plurality of logical blocks;
identifying two or more contiguous logical blocks in the plurality of logical blocks;
determining that one or more virtual blocks are mapped to the two or more contiguous logical blocks;
requesting storage of a data file on the one or more virtual blocks based on the one or more virtual blocks being mapped to the two or more contiguous logical blocks;
wherein the method is performed by at least one computing device.

26. The method as recited in claim 25, further comprising:
determining that the one or more virtual blocks are contiguous blocks;
wherein requesting storage of the data file on the one or more virtual blocks is further based on the one or more virtual blocks being contiguous blocks.

27. A non-transitory computer readable storage medium comprising instructions, which when executed by one or more processors, perform steps comprising:
accessing a virtual disk comprising a plurality of virtual blocks;
accessing a disk file associated with the virtual disk and comprising a plurality of logical blocks, wherein one or more virtual blocks, storing a data file, in the virtual disk are mapped to two or more non-contiguous logical blocks in the disk file;
re-mapping the one or more virtual blocks in the virtual disk to two or more contiguous logical blocks in the disk file;
transferring data from the two or more non-contiguous logical blocks in the disk file to the two or more contiguous logical blocks in the disk file.

28. The computer readable storage medium as recited in claim 27, wherein the one or more virtual blocks in the virtual disk comprises two non-contiguous virtual blocks in the virtual disk.

29. The computer readable storage medium as recited in claim 28, wherein re-mapping the one or more virtual blocks in the virtual disk to two or more contiguous logical blocks in the disk file comprises re-mapping the two non-contiguous virtual blocks in the virtual disk to the two or more contiguous logical blocks in the disk file.

30. The computer readable storage medium as recited in claim 27, wherein re-mapping the one or more virtual blocks in the virtual disk to the two or more contiguous logical blocks in the disk file is in response to detecting that:
the data file is stored on the one or more virtual blocks in the virtual disk; and
the one or more virtual blocks in the virtual disk are mapped to the two or more non-contiguous logical blocks in the disk file.

31. A non-transitory computer readable storage medium comprising instructions, which when executed by one or more processors, perform steps comprising:
accessing a virtual disk comprising a plurality of virtual blocks;
accessing a disk file comprising a plurality of logical blocks, wherein one or more source virtual blocks in the plurality of virtual blocks are mapped to two or more non-contiguous logical blocks in the plurality of logical blocks;
identifying one or more target virtual blocks in the plurality of virtual blocks that are mapped to two or more contiguous logical blocks in the plurality of logical blocks;
requesting transfer of a data file from the one or more source virtual blocks to the one or more target virtual blocks;
wherein transferring the data file from the one or more source virtual blocks to the one or more target virtual blocks results in transferring the data in the two or more non-contiguous logical blocks in the plurality of logical blocks to the two or more contiguous logical blocks in the plurality of logical blocks.

32. The computer readable storage medium as recited in claim 31, wherein the source virtual blocks are contiguous virtual blocks and the target virtual blocks are non-contiguous virtual blocks, and wherein transferring the data file from the one or more source virtual blocks to the one or more target virtual blocks comprises transferring the data file from the contiguous virtual blocks to the non-contiguous virtual blocks.

33. The computer readable storage medium as recited in claim 31,
wherein transferring the data file from the one or more source virtual blocks to the one or more target virtual blocks comprises fragmenting the data file on the virtual disk;
wherein transferring the data in the two or more non-contiguous logical blocks in the plurality of logical blocks to the two or more contiguous logical blocks in the plurality of logical blocks comprises defragmenting the data on the disk file.

34. The computer readable storage medium as recited in claim 31, wherein the one or more source virtual blocks are a first set of contiguous virtual blocks and the one or more target virtual blocks are a second set of contiguous virtual blocks, and wherein transferring the data file from the one or more source virtual blocks to the one or more target virtual blocks comprises transferring the data file from the first set of contiguous virtual blocks to the second set of contiguous virtual blocks.

35. The computer readable storage medium as recited in claim 31, wherein the one or more source virtual blocks and the one or more target virtual blocks share at least one overlapping block.

36. A non-transitory computer readable storage medium comprising instructions, which when executed by one or more processors, perform steps comprising:
accessing a virtual disk comprising a plurality of virtual blocks;
accessing a disk file associated with the virtual disk and comprising a plurality of logical blocks, wherein one or more virtual blocks, storing a data file, in the virtual disk are mapped to two or more non-contiguous logical blocks in the disk file;
reordering at least two logical blocks in the disk file such that the two or more non-contiguous logical blocks are reordered as two or more contiguous logical blocks.

37. The computer readable storage medium as recited in claim 36, wherein the two or more non-contiguous logical blocks are associated with two or more non-adjacent physical memory blocks, and wherein the two or more contiguous logical blocks are associated with two or more adjacent physical memory blocks.

38. A non-transitory computer readable storage medium comprising instructions, which when executed by one or more processors, perform steps comprising:
accessing a disk file associated with a virtual disk and comprising a plurality of logical blocks;
accessing a virtual disk comprising a plurality of virtual blocks, wherein each virtual block of the plurality of virtual blocks are mapped to one or more logical blocks in the plurality of logical blocks;
identifying two or more contiguous logical blocks in the plurality of logical blocks;
determining that one or more virtual blocks are mapped to the two or more contiguous logical blocks;
requesting storage of a data file on the one or more virtual blocks based on the one or more virtual blocks being mapped to the two or more contiguous logical blocks.

39. The computer readable storage medium as recited in claim 38, further comprising:
determining that the one or more virtual blocks are contiguous blocks;
wherein requesting storage of the data file on the one or more virtual blocks is further based on the one or more virtual blocks being contiguous blocks.
